(19) United States
(12) Patent Application Publication
(10) Pub. No.: US 2005/0187307 A1
(43) Pub. Date: Aug. 25, 2005

(54) Expandable styrene resin particles, expandable beads, and foamed article

(76) Inventors: Makoto Kunimi, Ichihara-shi (JP); Tetsuya Katou, Ichihara-shi (JP); Toshio Akima, Ichihara-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/985,971

(22) Filed: Nov. 12, 2004

Related U.S. Application Data
(63) Continuation-in-part of application No. 10/901,970, filed on Jul. 30, 2004.
Application No. 10/901,970 is a continuation of application No. 10/430,409, filed on May 7, 2003, now Pat. No. 6,797,733.

(30) Foreign Application Priority Data
May 8, 2002 (JP) 2002-132623
May 8, 2002 (JP) 2002-132624
Aug. 22, 2002 (JP) 2002-242015
Aug. 22, 2002 (JP) 2002-242016
Sep. 26, 2002 (JP) 2002-280359
Dec. 27, 2002 (JP) 2002-381173

(51) Int. Cl. C08J 9/00

(52) U.S. Cl. 521/50

(57) ABSTRACT

A process of producing expandable styrene resin particles, wherein in suspension polymerization of styrene monomers, styrene monomers are added to be adsorbed to styrene resin particles in the course of polymerization, while the concentration of oxygen in a reaction vessel is kept at 7 vol % or lower in a late stage of the polymerization, and the resulting styrene resin particles are impregnated with pentane as a foaming agent. The molecular weight in the outside of the particles obtained is selectively higher. The impregnation of pentane enables the particle to have low VOC (low volatile organic compound) properties. Furthermore the expanded particles have excellent appearance and strength since the outside thereof has a high molecular weight.

### BACKGROUND OF THE INVENTION

1. Field of the Invention

The present invention relates to expandable styrene resin particles, expandable styrene beads and a foamed article, particularly, those produced by using pentane.

2. Related Art

Recently in view of the environmental conservation and adverse influences on human bodies, materials for construction represented by building materials and structural members are demanded to have low VOC properties, that is, contain a reduced amount of volatile organic compounds (VOC) that vaporize into the air. As the definition of “VOC”, the World Health Organization (WHO) designates about 50 materials as a guideline based on the boiling points of organic compounds that vaporize at normal temperature. In Japan, the Health, Labor and Welfare Ministry shows guideline values of concentrations in the air for 14 materials.

Expandable styrene resins are featured by excellent adiathermancy, economical efficiency and hygiene and have been widely used in various food containers, packing materials, buffering materials and so on. The foamed molded articles can be produced by the following method. Expandable styrene resin particles are heated, for example, with steam and pre-expanded to a desired bulk density and the expanded particles are then subjected to an aging step. After the aging step, they fill in a molding die, and are heated, expanded again and molded.

Styrene monomers are polymerized and impregnated with a foaming agent, thereby producing expandable styrene resin particles. In expandable styrene resin particles, in order to impart plasticity to the particles, volatile organic compounds such as styrene monomers, toluene, ethylbenzene and xylene have been heretofore used. However at present it is strongly demanded not to use volatile organic compounds or to reduce the amounts thereof since expandable styrene resin particles with low VOC properties are required.

In expandable styrene resin particles, in order to obtain both high expandability and high quality of foamed articles such as appearance and strength in addition to low VOC properties, the molecular weight of resin particles has been reduced or a plasticizer that can function in the same manner as the volatile organic compounds has been used. In the case where butane is used as a foaming agent, generally particles become difficult to expand if the content of a volatile organic compound is reduced. Thus the amount of a volatile organic compound could not be sufficiently reduced. In the case where pentane is used as a foaming agent, pentane can also function as a plasticizer. Thus particles can be sufficiently expanded even if the amount of a volatile organic compound is reduced. However if particles produced by using pentane as a foaming agent are expanded at high expansion ratio, the expanded beads obtained remarkably shrink. Further the foamed articles obtained from the particles have the degraded quality such as appearance, fusing property and strength. Thus the particles cannot be used at high expansion ratio. In particular when pentane is used in the production of particles for applications such as food, e.g., fish containers, packing and buffering materials in which strength is mainly required, the expansion ratio can be increased to only 50 to 58 times in view of quality. As a result, their application is limited. Expandable styrene resin particles are then demanded which have low VOC properties and high usable limit of expansion ratio.

The present inventors have found that the molecular weight in the outside of expandable styrene resin particles increases while maintaining that in the inside thereof low by adding styrene monomers whiling reducing the oxygen concentration in a late stage of polymerization. Consequently they have developed expandable styrene resin particles with high expandability from which foamed articles having a high strength can be obtained.

### SUMMARY OF THE INVENTION

An object of the invention is to provide expandable styrene resin particles with the low VOC properties (low amount of volatile organic compounds) and high usable limit of expansion ratio, expandable styrene beads and foamed articles.

The present inventors have found that if pentane is used as a foaming agent and styrene monomers are added while reducing the oxygen concentration in a late stage of polymerization, that is, the molecular weight in the outside of particles is increased, expandable styrene rein particles with low VOC properties and high usable limit of expansion ratio can be obtained. The particles have good appearance and slightly shrink after expansion. Such particles could not be obtained with the use of pentane. The present invention can be made by the founding facts.

The present invention can provide the following expandable styrene resin particle, expandable styrene bead and foamed article.
1. A process of producing expandable styrene resin particles, comprising;
   suspension-polymerizing styrene monomers,
   adding styrene monomers to be adsorbed to styrene resin particles in the course of polymerization, while keeping the concentration of oxygen low by forced discharging of oxygen in a reaction vessel in a late stage of the polymerization, and
   impregnating styrene resin particles with pentane as a foaming agent.
2. A process of producing expandable styrene resin particles, comprising;
   suspension-polymerizing styrene monomers,
   adding styrene monomers to be adsorbed to styrene resin particles in the course of polymerization, while keeping the concentration of oxygen in a reaction vessel at 7 vol % or lower in a late stage of the polymerization, and
   impregnating styrene resin particles with pentane as a foaming agent.
3. A process of producing expandable styrene resin particles, comprising;
   suspension-polymerizing styrene monomers, while keeping the concentration of oxygen low by forced discharging of oxygen in a reaction vessel from start of the polymerization to a late stage of the polymerization,
   adding styrene monomers to be adsorbed to styrene resin particles in the course of polymerization while keeping the concentration of oxygen low, and
   impregnating styrene resin particles with pentane as a foaming agent.
4. A process of producing expandable styrene resin particles, comprising;
   suspension-polymerizing styrene monomers, while keeping the concentration of oxygen in a reaction vessel at 7 vol % or lower from start of the polymerization to a late stage of the polymerization,
   adding styrene monomers to be adsorbed to styrene resin particles in the course of polymerization, while keeping the concentration of oxygen at 7 vol % or lower, and
   impregnating styrene resin particles with pentane as a foaming agent.
5. A process of producing expandable styrene resin particles, comprising;
   suspension-polymerizing styrene monomers, while keeping the concentration of oxygen in a reaction vessel at 1 vol % or lower from start of the polymerization to a late stage of the polymerization,
   adding styrene monomers to be adsorbed to styrene resin particles in the course of polymerization, while keeping the concentration of oxygen at 1 vol % or lower, and
   impregnating styrene resin-particles with pentane as a foaming agent.
6. The process of producing expandable styrene resin particles according to any one of 1 to 5, wherein the late stage of the polymerization is a stage in which the polymerization rate is 60% or higher.
7. The process of producing expandable styrene resin particles according to any one of 1 to 6, wherein the amount of the additional styrene monomers is 5 wt % to 30 wt % of the expandable styrene resin particles.
8. Expandable styrene resin particles obtained by the process of any one of 1 to 7.
9. An expandable styrene resin particle comprising pentane impregnated therein, wherein the weight average molecular weight of a surface portion from the surface of the particle to a depth of ⅕ of its radius toward the center is higher than that of a central portion from the center to a distance of ⅕ of the radius toward the surface, and a chart of gel permeation chromatography of the surface portion has two crests or a shoulder.
10. The particle according to 9, wherein the weight average molecular weight of the central portion is 200,000 to 300,000,
   the weight average molecular weight of the surface portion is 300,000 to 450,000, and
   the weight average molecular weight of the surface portion is at least 1.2 times as large as that of the central portion.
11. An expandable styrene resin particle comprising pentane impregnated therein, wherein the inclination of a correlation expression of a logarithm (R.M.S radius) and a logarithm (MW), measured by a GPC/MALLS method, of a surface portion from the surface of the particle to a depth of ⅕ of the radius toward the center is not larger than 0.53.
12. An expandable styrene resin particle comprising pentane impregnated therein, wherein when a surface portion from the surface of the particle to a depth of ⅕ of the radius toward the center is further divided into 6 equal portions from the surface toward the center of the particle, the weight average molecular weights of parts constituting from the surface to the ⅙ to 6/6 portions do not decrease toward the surface of the particle.
13. The particle according to 12, wherein a ratio (B)/(A)×100(%) is at least 130
   wherein (B) is the weight average molecular weight of the outermost portion out of the 6 equal portions, and (A) is the weight average molecular weight of the whole particle.
14. An expandable styrene resin particle comprising pentane impregnated therein, wherein a chart of gel permeation chromatography of a surface portion from the surface of the particle to a depth of ⅕ of the radius toward the center has two crests or a shoulder, and
   a ratio (B)/(A)×100(%) is at least 130
   wherein (B) is the weight average molecular weight of an outermost portion out of 6 equal portions obtained by dividing the surface portion into the 6 equal portions from the surface toward the center of the particle, and (A) is the weight average molecular weight of the whole particle.
15. An expandable styrene resin particle comprising pentane impregnated therein, wherein the usable limit of expansion ratio of the particles is 60 ml/g or more.
16. An expandable styrene bead obtained by expanding the particle of any one of 8 to 15.
17. A foamed article obtained by molding the beads of 16.
18. A foamed article according to 17, whose the expansion ratio is 60 ml/g or more.
19. A foamed article according to 18, whose the expansion ratio is 60 ml/g or more.

According to the present invention, there can be obtained expandable styrene resin particle with low VOC properties (low amount of volatile organic compounds) and high usable limit of expansion ratio, and expandable styrene bead and foamed article obtained therefrom.

### BRIEF DESCRIPTION OF THE DRAWINGS

FIG. 1 is a diagram for explaining a method of measuring the molecular weights of 5 equally divided portions of a particle.

FIG. 2 is a diagram for explaining a method of measuring the molecular weights of 6 equally divided portions of the outermost portion out of 5 equally divided portions of a particle.

FIG. 3 is a GPC chart of particles obtained in Example 1.

FIG. 4 is GPC charts having two crests or a shoulder.

### DETAILED DESCRIPTION OF THE PREFERRED EMBODIMENTS

The expandable styrene resin particles of the present invention can be obtained by polymerizing styrene monomers. As the styrene monomers, styrene itself or mixed monomers comprising styrene as an essential component, and a styrene derivative such as α-methylstyrene, chlorstyrene or vinyltoluene, an acrylic ester such as methyl acrylate, ethyl acrylate or butyl acrylate, or a methacrylic ester such as methyl methacrylate, ethyl methacrylate or butyl methacrylate can be used. Further, a crosslinking agent such as divinylbenzene or diallyl phthalate can be used.

A process for producing the expandable styrene resin particles is preferably suspension polymerization, and a conventionally known process can be employed. The polymerization is generally carried out by dispersing styrene monomers having a catalyst such as an organic peroxide dissolved therein into an aqueous medium containing a dispersant so as to produce radicals.

As the dispersant, a hardly soluble inorganic salt and a surfactant may be used in combination or a conventionally known dispersant such as an organic dispersant, e.g., PVA can also be used.

As the hardly soluble inorganic salt, magnesium phosphate, tricalcium phosphate and the like can be used. As the surfactant, sodium oleate, sodium dodecylbenzenesulfonate as well as an anionic surfactant and a nonionic surfactant which are generally used in suspension polymerization can be used. As the organic dispersant, a polyvinyl alcohol, a polyvinyl pyrrolidone, methylcellulose and the like can be used.

As the organic peroxide, a conventionally known organic peroxide having a 10-hour-half decomposition temperature of 50 to 100° C. can be used. For example, lauroyl peroxide, benzoyl peroxide, t-butyl peroxybenzoate, t-butylperoxyisopropyl carbonate and the like can be used. The organic peroxide is preferably used in an amount of 0.001 to 0.5 wt % based on the polymerizable monomer. One or two or more organic peroxides can be used.

The molecular weight of the whole resin particles can be controlled by adjustment of the concentration of the catalyst, the use of a chain transfer agent, or both of these.

As the chain transfer agent, conventionally known chain transfer agents such as octyl mercaptan, dodecyl mercaptan, an α-methylstyrene dimer and the like can be used. The chain transfer agent is preferably used in an amount of 20 to 100 ppm based on the polymerizable monomers.

In the producing process of the present invention, a reaction is allowed to proceed by addition of styrene monomers, keeping the concentration of oxygen in a reaction vessel low at least in the late stage of polymerization, and the resulting styrene resin particles are impregnated with an easily evaporating foaming agent before or after completion of the polymerization reaction.

In this process, the concentration of oxygen in the reaction vessel may be kept low from the start or in the middle of the polymerization, and the concentration of oxygen must be low at least in the late stage of the polymerization.

In general, when the polymerization proceeds with oxygen present in the reaction vessel, the amount of low-molecular-weight products formed in styrene resin particles increases. Particularly, since the amount of residual polymerization catalyst is small and radicals are stopped in the late polymerization stage, the low-molecular-weight products are liable to be produced on the surface of the styrene resin particles, thereby impairing the appearance of a molded article.

Meanwhile, in the production process of the present invention, since the concentration of oxygen in the reaction vessel is kept low in the late polymerization stage, the occurrence of such low-molecular-weight products can be inhibited. The concentration of oxygen is kept at preferably 7 vol % or lower, more preferably 5 vol % or lower, particularly preferably 1 vol % or lower. The concentration of oxygen can be controlled by forced discharge of oxygen in the reaction vessel, for example, by substitution with an inert gas such as nitrogen.

Further, the late polymerization stage is a stage with a polymerization rate of preferably not lower than 60%, more preferably not lower than 60% but lower than 97%.

When the polymerization rate is lower than 60%, absorption of the styrene monomers into the styrene resin particles is promoted, and the molecular weight of the central portion becomes high, whereby an expanding force and fusion of the molded article may deteriorate. Meanwhile, when the polymerization rate is equal to or higher than 97%, there is a possibility that absorption of the styrene monomers into the resin particles lowers, the amounts of radicals and polymerization catalyst in the resin particles decrease, and the molecular weight of the outermost portion of resin particles becomes low, so that thermal fusion at the time of expand-molding is promoted excessively, whereby the strength and surface finish of the molded article may be degraded. Addition of the monomers at a polymerization rate of not lower than 85% but lower than 97% is more preferable.

According to a first production process of the present invention, in suspension polymerization, additional styrene monomers are added at a polymerization rate of not lower than 60%, preferably not lower than 60% but lower than 97%, while the concentration of oxygen in a reaction vessel is kept at 7 vol % or lower.

If the styrene monomers are added while the concentration of oxygen is higher than 7 vol %, low-molecular-weight products may be produced in the surface layer of styrene resin particles. The low-molecular-weight products produced in the surface promote thermal fusion at the time of heat-expand-molding excessively, thereby degrading the strength and surface finish of a molded article.

Further, according to a second production process of the present invention, in suspension polymerization, the concentration of oxygen in a reaction vessel is kept at 7 vol % or lower, particularly 1 vol % or lower during from the start of polymerization to a polymerization rate of not lower than 60%, preferably not lower than 60% but lower than 97%, and additional styrene monomers are added at the polymerization rate of not lower than 60%, preferably not lower than 60% but lower than 97%.

In this case, before the polymerization starts, oxygen in the reaction vessel is substituted with nitrogen or the like so as to adjust the concentration of oxygen in the reaction vessel to 1 vol % or lower in advance. The lower the concentration of oxygen is, the more preferable it is. Thereafter, to allow the polymerization to proceed, feeding of nitrogen or the like into the reaction vessel may be continued or the reaction vessel may be sealed after completion of substitution so as to prevent oxygen from entering the reaction vessel.

When the polymerization proceeds in a sealed reaction vessel, oxygen contained in water and styrene monomers, oxygen trapped in a liquid by agitation and oxygen produced at the time of the polymerization reaction are generated along with an increase in the temperature of the polymerization reactants from a feed temperature to a reaction temperature or along with a reaction of a polymerization catalyst. Hence, when the concentration of oxygen exceeds 1 vol %, oxygen is substituted with nitrogen or the like again.

The concentration of oxygen in the reaction vessel is controlled to be at 1 vol % or lower until addition of an additional styrene monomers is completed. To keep the concentration of oxygen at 1 vol % or lower during the polymerization, the connection of an oximeter is recommended.

When the concentration of oxygen is 1 vol % or lower, the molecular weight becomes further higher, whereby the strength of a molded article can be rendered high.

The styrene monomers are preferably added in an amount of 5 to 30 wt %, more preferably 10 to 15 wt %, based on finally obtained styrene resin particles.

When the amount is smaller than 5 wt %, the molecular weight of the outermost portion of the styrene resin particles may not be sufficiently high. As a result, the strength may not be improved sufficiently. Meanwhile, when the amount is larger than 30 wt %, the resin particles may be softened, absorption of the styrene monomers may be promoted, and the molecular weight of the central portion of particles may become higher, i.e., a part with the highest molecular weight may be closer to the central portion of the particles, so that an expanding force lowers and an molded article may hardly be fused accordingly.

The suspension polymerization temperature is generally 80 to 95° C. The additional styrene monomers may be added at the temperatures or at higher temperatures. In consideration of the industrial production efficiency that the amount of styrene monomers remaining in the finally obtained expandable styrene resin particles is reduced, the polymerization temperature is preferably not lower than 90° C., and the styrene monomers are preferably added during temperature increasing.

In the production process of the present invention, it is preferred that the polymerization be started when a hydrogen ion concentration in an aqueous dispersion is 8 to 10 and an additional hardly soluble inorganic salt be added at least once at a polymerization rate of 20 to 50%. The aqueous dispersion is preferably a continuous phase.

When the hydrogen ion concentration is out of the above range, particle size distribution at the completion of the suspension polymerization may not be sharp. The hydrogen ion concentration can be adjusted by use of a basic inorganic salt.

Further, due to the same reason, an additional hardly soluble inorganic salt can be added at a polymerization rate of 20 to 50%.

The hardly soluble inorganic salt can be additionally added at least once, e.g., two or three times. Further, the hardly soluble inorganic salt can be additionally added after the polymerization further proceeds.

A foaming agent can be added under pressure along with addition of the styrene monomers and be impregnated with the styrene resin particles before or after completion of a polymerization reaction. Generally, it is preferred that the foaming agent is impregnated after addition of the styrene monomers before completion of a polymerization reaction.

In the present invention, pentane is used as a foaming agent. Pentane includes isopentane, normal pentane and mixture thereof. For example, isopentane and normal pentane are mixed and used in which the weight ratio of isopentane:normal pentane is 10 to 50:90 to 50, preferably 15 to 25:85 to 75.

The use amount of a foaming agent, which can be selected properly, is generally 3 to 8 parts by weight, preferably 4 to 7 parts by weight per 100 parts by weight of the obtained expandable resin particles.

Further, as a foaming assistant, an alicyclic hydrocarbon such as cyclohexane or an aromatic hydrocarbon as well as an aliphatic hydrocarbon can be used in combination with the foaming agent. For example, cyclohexane may be used, generally in 20 to 60 parts by weight per 100 parts by weight of pentane.

In the polymerization, additives used in production of expandable styrene resin particles, such as a solvent, a plasticizer, an expandable cell nucleating agent, a filler, a flame retardant, a flame retardant assistant, a lubricant and a colorant may be used as required.

Further, in the production process of the present invention, a seed polymerization process using expandable styrene resin particles or regenerated styrene resin particles as seeds can also be employed. In this process as well, the concentration of oxygen is controlled to be low and pentane is used as a foaming agent, as described above.

After impregnated with the foaming agent, discharged from the polymerization system and dried through dehydration, the expandable styrene resin particles may be coated with a surface coating agent as required. As the coating agent, a conventionally known coating agent which has been applied to expandable styrene resin particles can be employed. Illustrative examples of such a coating agent include zinc stearate, triglyceride stearate, monoglyceride stearate, a castor hardened oil, an amide compound, silicones, and an antistatic agent.

In general, the weight average molecular weight (molecular weight) of the expandable styrene resin particles produced by suspension polymerization is determined by the amount of polymerization catalyst, and the molecular weights of the central, middle and surface-layer portions of particles are approximately the same.

However, according to the foregoing first and second production processes of the present invention, expandable styrene resin particles whose surface portions have a higher molecular weight than these central portions are obtained. The gradient of the molecular weight from the center to the surface of particles is not a gradual increase at a given rate, but the molecular weight sharply increases near the surface.

The expandable styrene resin particles obtained by the production process of the present invention has a much higher molecular weight near the surface than the rest of the particle. Therefore, it can have a high molecular weight in the surface portion with the molecular weight of the central portion kept low. In general, when the central portion has a low molecular weight, good expandability can be exhibited, while when the surface portion has a high molecular weight, a molded article has high strength. Thus, the particles of the present invention can satisfy both expandability and the strength of a molded article. For example, a molded article having relatively high strength can be obtained with a certain degree of expandability maintained.

In particular, the expandable styrene resin particles can be obtained in which the weight average molecular weight of a surface portion from the surface of the particles to a depth of ⅕ of the radius toward the center is higher than that of a central portion from the center to a distance of ⅕ of the radius toward the surface.

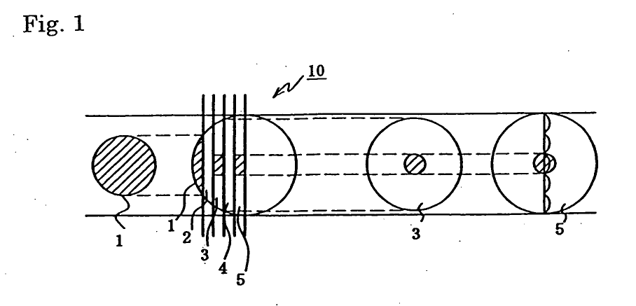

Next, the surface portion and the central portion will be described with reference to FIG. 1. As shown in FIG. 1, a resin particle 10 is divided into 5 equal portions from the surface toward the center. An outermost portion 1 out of the 5 portions is the surface portion. The weight average molecular weight of the surface portion is that of the portion 1. An innermost portion 5 out of the 5 portions is the central portion. The weight average molecular weight of the central portion is that of a middle portion out of 5 equally divided portions of the portion 5.

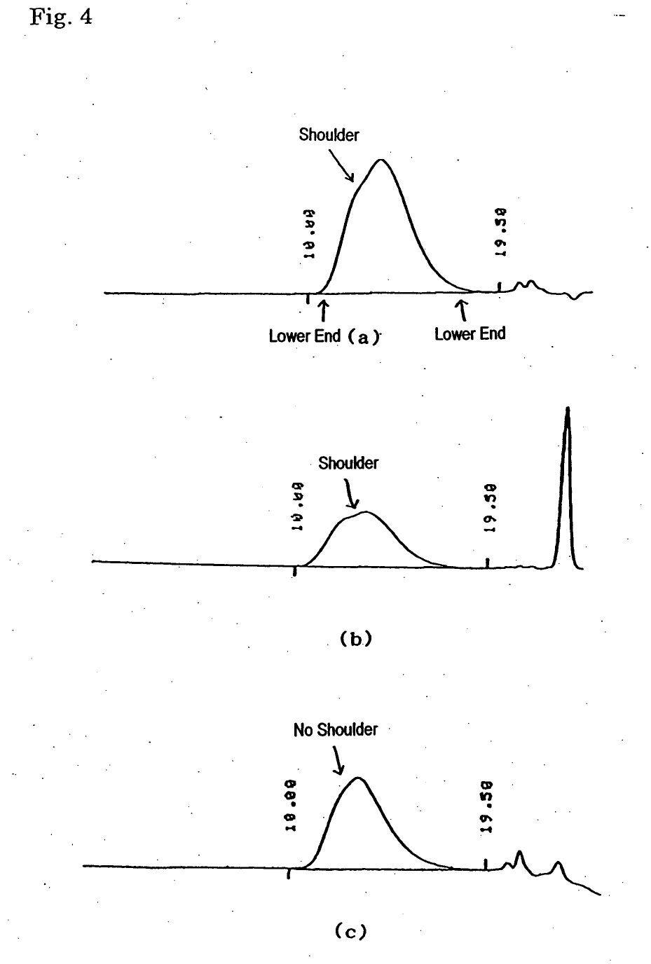

Further, it is preferred that a chart of gel permeation chromatography of the surface portion have two crests or a shoulder. Having the two mountains or shoulder indicates that the molecular weight is changing abruptly. The shoulder is formed by an inflection point. In the present invention, the chart by gel permeation chromatography is measured by use of two GL-R400M columns of Hitachi Chemical Co., Ltd. The charts having two crests or a shoulder are exemplified in FIG. 4. That is to say, FIG. 4 (a) indicates a chart having a shoulder, FIG. 4(b) indicates a chart having two crests and FIG. 4(c) indicates a chart without a shoulder. As shown in FIG. 4(a), the chart generally has inflection points at both lower ends as well, however, the present invention does not count these points as shoulders.

Further, in the present invention, it is preferred that the weight average molecular weight of the central portion be 200,000 to 300,000, the weight average molecular weight of the surface portion be 300,000 to 450,000 and the weight average molecular weight of the surface portion be at least 1.2 times as large as that of the central portion.

When the molecular weight of the central portion is smaller than 200,000, the strength of a molded article may be low. Further, to render the molecular weight smaller than 200,000, the amount of catalyst used in a production process must be increased disadvantageously.

Meanwhile, when the molecular weight of the central portion is larger than 300,000, expandability may be low.

Further, the weight average molecular weight of the central portion is preferably 200,000 to 250,000. The molecular weights of the three innermost portions out of the 5 portions are preferably substantially the same.

When the molecular weight of the surface portion is smaller than 300,000, a molded article may not be able to have sufficient strength.

When the molecular weight of the surface portion is larger than 450,000, an expanding force may lower, thermal fusion may not proceed, the surface finish of the molded article may become poor, and fusion hardly occurs.

Further, the weight average molecular weight of the surface portion is preferably 350,000 to 450,000.

Further, according to the production process of the present invention, grafting which has been conceived not to occur in conventional radical polymerization of styrene occurs in the surface portion, whereby a high-molecular-weight branching structure can be produced.

It can be known that the surface portion has the branching structure, because the inclination of a correlation expression of a logarithm (R.M.S radius) and a logarithm (MW), measured by a GPC/MALLS method, of the surface portion from the surface of the particle to a depth of ⅕ of the radius toward the center is not larger than 0.53, preferably not larger than 0.52, more preferably not larger than 0.50. In the above description, GPC stands for gel permeation chromatography, MALLS stands for Multi Angle Laser Light Scattering, an R.M.S radius refers to a Root Mean Square radius, and MW refers to an absolute molecular weight.

The above inclination is 0.55 to 0.60 for a linear polystyrene obtained by general radical polymerization (suspension-based).

Further, due to the same reason as above, the weight average molecular weight of the surface portion is preferably 300,000 to 450,000.

Further, according to the foregoing second production process of the present invention, a decrease in molecular weight at the end of a polymerization reaction, that is, in a portion near the surface, can be prevented by keeping the concentration of oxygen at 1 vol % or lower from the start of the polymerization to the late stage of the polymerization.

In particular, in the expandable styrene resin particles of the present invention, when a surface portion from the surface of a particle to a depth of ⅕ of the radius toward the center is further divided into 6 equal portions from the surface toward the center of the particle, the weight average molecular weights of parts constituting from the surface to the ⅙ to 6/6 portions preferably do not decrease toward the surface of the particle, more preferably increase toward the surface thereof.

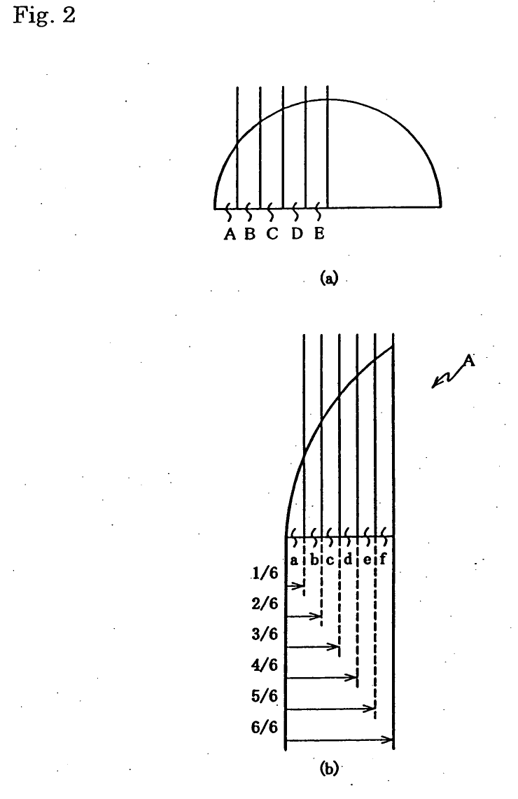

Next, the “parts constituting from the surface to the ⅙ to 6/6 portions” will be described with reference to FIG. 2. As shown in FIG. 2(a), firstly, a resin particle 10 is halved, and then a half thereof is divided into 5 equal portions from the surface toward the center. An outermost portion A out of the 5 equal portions is further divided into 6 equal portions as shown in FIG. 2(b). The above “parts constituting from the surface to the ⅙ to 6/6 portions” are the parts from the surface to these 6 portions respectively.

In the present invention, it is preferred that the weight average molecular weight (B) of the outermost portion out of the 6 equal portions be larger than that (A) of the whole resin particle. In particular, a ratio (B)/(A)×100(%) is more preferably at least 130.

By making the molecular weight of the outermost portion relatively higher, the strength of a molded article can be further increased.

Pentane is impregnated in the resin particles obtained by the production process of the present invention, since pentane is used as a foaming agent. The resin particles of this invention have a good appearance and strength, even if it is expaned at a high expansion ratio. This is probably due to the high molecular weight of the outside of the resin particles. In other words, during or after the expanding, a part of pentane is replaced with the air. At this time, conventional resin particles shrink by the air pressure. However, the resin particles of the present invention slightly shrink, probably, since the molecular weight of the outside thereof is high. As a result, resin particles with high usable limit of expansion ratio and low VOC properties can be obtained by employing pentane as a foaming agent. For example, particles having usable limit of expansion ratio of 60 ml/g or more, about 60 ml/g to about 65 ml/g, which has not been obtained conventionally, can be obtained by using pentane. Compared with the case of using butane as a foaming agent, the amount of dissipated foaming agent is low and the amount of foaming agent used is reduced. As a result, the amount of the foaming agent released into atmospheric ambient can be considerably reduced. Further, the amount of residual monomers can also be considerably reduced.

In the present invention, “usable limit of expansion ratio (ml/g)” means the largest ratio among the expanding ratios at which foamed articles can be produced by expanding expandable resin particles, of which the appearance (smoothness of surface) is 90% or more when measured by the measuring method described in Examples, and of which the flexural strength is 0.285 MPa or more when measured by the measuring method described in Examples.

Expandable beads of the present invention are produced by expanding the expandable styrene resin particles. Further, a foamed article of the present invention is produced by molding the above expandable beads.

In general, the expandable styrene resin particles are heated by steam or the like to be pre-foamed to a given bulk density and then subjected to an aging step to produce the expandable beads. Thereafter, the expandable beads are filled in a mold and foamed under heating again, thereby producing the expand-mold product.

### EXAMPLES

Methods of evaluating properties in examples and comparative examples are as follows.

(1) Weight Average Molecular Weight (Molecular Weight)

The molecular weight of expandable styrene resin particles was measured after expanding the particles. The expandable styrene resin particles were expanded in saturated steam to a bulk density of 80 ml/g. However, the expandable styrene resin particles shown in comparative examples were not expanded to a bulk density of 80 ml/g because of shrinkage thereof. Therefore the molecular weights thereof were measured when reaching a bulk density of 75 ml/g in comparative example 1, a bulk density of 70 ml/g in comparative example 2 and a bulk density of 75 ml/g in comparative example 3, respectively.

<Method of Measuring Molecular Weights of 5 Equally Divided Portions of Particle>

Two or three expanded particles were picked. A half of a particle 1 was divided into 5 equal portions by use of a razor as shown in FIG. 1 so as to form portions 1, 2, 3, 4 and 5 from the surface. The molecular weight of the outermost portion 1 (surface portion) was measured as it was. As for the innermost portion 5 (central portion), the portion was divided into 5 equal portions, a middle portion was hollowed out by use of an injection needle (diameter: 0.6 to 0.7 mm), and the molecular weight of the hollowed portion was measured. As for the portion 3 (corresponding to ⅗ portion from the center), a middle portion was hollowed out by use of an injection needle as in the case of the portion 5, and the molecular weight of the hollowed portion was measured. For the expandable resin particles that did not reach a bulk density of 80 ml/g because of shrinkage, expanded particles with no shrinkage (low bulk density) were measured with the same instrument since it is difficult to change the size of an injection needle.

The molecular weights were measured in accordance with a gel permeation chromatography (GPC) method by use of the following devices and conditions. Further, a chart (GPC chart) of the surface portion was obtained. Measuring Device: manufactured by HITACHI CO., LTD.
Eluent: THF, Flow Rate: 2 ml/min
Detector: UV 220 nm
Column: Two GL-R400M columns of HITACHI CHEMICAL CO., LTD.
   <Method of Measuring Molecular Weights of 6 Equally Divided Portions of Surface Portion out of 5 Equally Divided Portions of Particle>

The molecular weights of “parts constituting ⅙ to 6/6 from the surface” were measured in the following manner. As shown in FIG. 2(a), firstly, an expanded particle 10 was halved, and a half thereof was further divided into 5 equal portions from the surface toward the center. An outermost portion A from the surface to a depth of ⅕ was further cut into 6 equal portions under a microscope as shown in FIG. 2(b) so as to obtain portions a, b, c, d, e and f. The molecular weights of the portions a, b, c, d, e and f were measured. The molecular weight of the portion a was the molecular weight of a portion from the surface to a depth of ⅙. An average of the molecular weights of the portions a and b was the molecular weight of the portion from the surface to a depth of 2/6. An average of the molecular weights of the portions a, b and c is the molecular weight of the portion from the surface to a depth of 3/6. An average of the molecular weights of the portions a, b, c and d is the molecular weight of the portion from the surface to a depth of 4/6. An average of the molecular weights of the portions a, b, c, d and e is the molecular weight of the portion from the surface to a depth of ⅚. An average of the molecular weights of the portions a, b, c, d, e and f is the molecular weight of the portion from the surface to a depth of 6/6.

The molecular weights were measured by a GPC method as in the above case.

(2) Expandability

To determine expandability, there was measured a bulk density (degree of expansion) when expandable styrene resin particles containing 6.5 wt % of volatile components were expanded in boiling water at 100° C. for 3 minutes.

The amount of volatile components was defined as the following. The expandable styrene resin particles were placed in a vessel and weighed. Next the resin particles were left for 7 minutes in a drier of explosion-protection type set at 195° C. (±1° C.) and then taken out. The resin particles were cooled in a desiccator and weighed. The loss amounts of the particles were calculated by the following equation.
(the resin weight before the drying−the resin weight after the drying)/(the resin weight before the drying)×100=(%)

(3) Flexural Strength

Expandable styrene resin particles were expanded by 63 times or 58 times using an HBP-700 expanding machine of HITACHI TECHNOPLANT CO., LTD. to obtain expandable beads. Then, the expandable beads were molded by use of a VS-500 molding machine of DAISEN KOUGYO CO., LTD. at a steam pressure of 0.08 MPa to obtain a molded article having a size of 550 mm×335 mm×150 mm.

The flexural strength of the foamed article having a density of 60 ml/g or 55 ml/g was measured in accordance with JIS-A-9511.

(4) Analysis of Polymer Structure of Surface Portion by GPC/MALLS Method

A surface portion 1 shown in FIG. 1 was used as a sample to be measured. The GPC/MALLS method was carried out by use of the following devices and conditions. In consequence, the inclination of a correlation expression of a logarithm (R.M.S radius) and a logarithm (MW) was determined.
Column: Shodex, KF-807L (x 2)
Column Temperature: 40° C.
Eluant: THF
Flow Rate: 1.00 ml/min
Amount of Injection: 100 μL
Detector: RI and Wyatt Technology, DAWN DSP-F (Laser Wavelength: 632.8 nm)
Multi Angle Fitting Method: Berry Method

(5) Appearance (Smoothness of Surface)

Black printing ink was applied thinly on the surface of a molded article (expansion ratio of all the expandable beads: 60 ml/g) produced in the same manner as in (3) by use of a roller, and the applied surface portion was subjected to an image processor. Since voids on the surface portion were not coated with the ink, the area of the black portion with respect to the whole applied area was determined as a degree of smoothness of the surface and a value for evaluating the appearance of the molded article.

(6) Rate of Polymerization

A rate of polymerization was measured by sampling resin particles during synthesis by use of the following devices and conditions.
Measuring Device: manufactured by HITACHI CO., LTD.
Eluant: acetonitrile/distilled water=70/30
Flow Rate: 1 ml/min
Detector: UV 230 nm
Column: Inertsil ODS-2

(7) Volatile Organic Compound Content

The content of volatile organic compounds in resin particles was measured with the following device under the following conditions.
Measuring Device: Gas chromatography manufactured by SHIMAZUSEISAKUSYO CO., LTD.
Detector: FID
Injection temperature: 200° C.
Carrier gas:
   Nitrogen: 0.3 MPa, 40 ml/min
   Hydrogen: 0.06 MPa, 50 ml/min
   Air: 0.07 MPa, 300 ml/min
Column: PEG-20MT
Column temperature: 105° C.
Measured substance: Styrene, toluene, ethylbenzene, p-xylene, m-xylene, o-xylene, 1-propylbenzene and so on

(8) Usable Limit of Expansion Ratio

Among the expansion ratios at which foamed articles of which the appearance (smoothness rate of surface) is 90% or more and of which the flexural strength is 0.285 MPa or more can be produced by expanding expandable particles, the largest ratio is the usable limit of expansion ratio.

### EXAMPLE 1

After the inside of a 14-liter autoclave equipped with an agitator was substituted with nitrogen gas, 6,000 g of pure water, 9 g of tricalcium phosphate, and 0.12 g of sodium dodecylbenzenesulfonate were charged in the autoclave under an agitation of 230 rpm. Subsequently, 5,400 g of styrene, 22.4 g (Wet 75%) of benzoyl peroxide, 2.4 g of t-butyl peroxyisopropylcarbonate, and 3 g of ethylenebisamide were charged under agitation. After completion of charging, the polymerization vessel was sealed, a pipe for blowing was opened, and the vessel was substituted with nitrogen gas again. At this time, the concentration of oxygen measured with an oximeter was 0.7 vol %. After the vessel was heated to 90° C., it was substituted with nitrogen gas again so that the concentration of oxygen was 0.5 vol %, and 3 g of tricalcium phosphate was added two hours and three hours after completion of temperature rising, respectively. Then, upon keeping the content of the vessel at 90° C. for 2.5 hours, 6 g of tricalcium phosphate and 0.12 g of sodium dodecylbenzenesulfonate were added when a rate of polymerization was 95%. At this time, the concentration of oxygen was 0.5 vol %. Thereafter, 600 g of styrene was added dropwise continuously over 3 hours while the temperature was raised to 100° C.

Then, 90 g of cyclohexane was added under pressure, and after 1 hour, 420 g of pentane (isopentane/normal pentane ratio=2/8) was added under pressure in 1 hour, and then the content of the vessel was kept for another 6 hours. Thereafter, the content was cooled to room temperature and then taken out of the autoclave. After the taken out slurry was washed, dehydrated and dried, the resulting product was classified by passing through a 14 mesh and being caught in a 26 mesh and then coated with 0.08% of zinc stearate, 0.05% of castor hardened oil and 0.02% of dimethyl silicone to obtain expandable styrene resin particles.

The molecular weight, residual monomer content and properties of the obtained expandable styrene resin particles were measured, and the results are shown in Table 1.

As shown in Table 1, the molecular weight of the surface portion was the same as that of the 6/6 portion of the ⅕ portion from the surface.

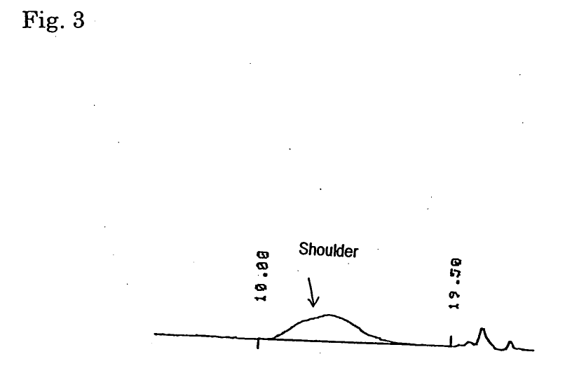

In addition, a chart (GPC chart) of a surface portion was measured by a GPC method. The chart is shown in FIG. 3.

### EXAMPLE 2

In a 14-liter autoclave equipped with an agitator, 6,000 g of pure water, 9 g of tricalcium phosphate and 0.12 g of sodium dodecylbenzenesulfonate were charged under an agitation of 230 rpm. Subsequently, 5,400 g of styrene, 22.4 g (Wet 75%) of benzoyl peroxide, 2.4 g of t-butyl peroxyisopropylcarbonate, and 3 g of ethylenebisamide were charged under agitation. After completion of charging, the polymerization vessel was sealed, a pipe for blowing was opened, and the vessel was substituted with nitrogen gas. At this time, the concentration of oxygen measured with an oximeter was 5.9 vol %. The vessel was then heated to 90° C., and 3 g of tricalcium phosphate was added 2 hours and 3 hours after completion of temperature rising, respectively. Then, upon keeping the content of the vessel at 90° C. for 2.5 hours, 6 g of tricalcium phosphate and 0.12 g of sodium dodecylbenzenesulfonate were added when a rate of polymerization was 95%. At this time, the concentration of oxygen was 3.9 vol %. Thereafter, 600 g of styrene was added dropwise continuously over 3 hours while the temperature was raised to 100° C.

The procedures thereafter including impregnation with a foaming agent were repeated in the same way of Example 1. The molecular weight, residual monomer content and properties of the obtained expandable styrene resin particles were measured, and the results are shown in Table 1.

### EXAMPLE 3

In a 14-liter autoclave equipped with an agitator, 6,000 g of pure water, 9 g of tricalcium phosphate and 0.12 g of sodium dodecylbenzenesulfonate were charged under an agitation of 230 rpm. Subsequently, 5,400 g of styrene, 22.4 g (Wet 75%) of benzoyl peroxide, 2.4 g of t-butyl peroxyisopropylcarbonate, and 3 g of ethylenebisamide were charged under agitation. After completion of charging, the vessel was heated to 90° C. and a pipe for blowing was opened to promote the polymerization. Three g of tricalcium phosphate was added 2 hours and 3 hours after completion of temperature rising, respectively. Then, upon keeping the content of the vessel at 90° C. for 2 hours, and the vessel was substituted with nitrogen gas until the concentration of oxygen was 6.5 vol %. When a rate of polymerization was 95%, 6 g of tricalcium phosphate and 0.12 g of sodium dodecylbenzenesulfonate were added. Thereafter, 600 g of styrene was added dropwise continuously over 3 hours while the temperature was raised to 100° C.

The procedures thereafter including impregnation with a foaming agent were repeated in the same way of Example 1. The molecular weight, residual monomer content and properties of the obtained expandable styrene resin particles were measured, and the results are shown in Table 1.

### COMPARATIVE EXAMPLE 1

In a 14-liter autoclave equipped with an agitator, 6,000 g of pure water, 9 g of tricalcium phosphate and 0.12 g of sodium dodecylbenzenesulfonate were charged under an agitation of 230 rpm. Subsequently, 6,000 g of styrene, 20.0 g (Wet 75%) of benzoyl peroxide, 2.4 g of t-butyl peroxyisopropylcarbonate, and 3 g of ethylenebisamide were charged under agitation. After completion of charging, the vessel was heated to 90° C. and a pipe for blowing was opened to promote the polymerization. Three g of tricalcium phosphate was added 2 hours and 3 hours after completion of temperature rising, respectively. Then, upon keeping the content of the vessel at 90° C. for 2.5 hours, 6 g of tricalcium phosphate and 0.12 g of sodium dodecylbenzenesulfonate were added when a rate of polymerization was 95%. At this time, the concentration of oxygen was 13.2 vol %. Thereafter, the temperature was raised to 100° C. over 1 hour.

The procedures thereafter including impregnation with a foaming agent were repeated in the same way of Example 1. The molecular weight, residual monomer content and properties of the obtained expandable styrene resin particles were measured, and the results are shown in Table 1.

### COMPARATIVE EXAMPLE 2

In a 14-liter autoclave equipped with an agitator, 6,000 g of pure water, 9 g of tricalcium phosphate and 0.12 g of sodium dodecylbenzenesulfonate were charged under an agitation of 230 rpm. Subsequently, 6,000 g of styrene, 24.0 g (Wet 75%) of benzoyl peroxide, 2.4 g of t-butyl peroxyisopropylcarbonate, and 3 g of ethylenebisamide were charged under agitation. After completion of charging, the vessel was heated to 90° C. and a pipe for blowing was opened to promote the polymerization. 3 g of tricalcium phosphate was added 2 hours and 3 hours after completion of temperature rising, respectively. Then, upon keeping the content of the vessel at 90° C. for 2 hours, 6 g of tricalcium phosphate and 0.12 g of sodium dodecylbenzenesulfonate were added when a rate of polymerization was 95%. At this time, the concentration of oxygen was 13.5 vol %. Thereafter, the temperature was raised to 100° C. over 1 hour.

The procedures thereafter including impregnation with a foaming agent were repeated in the same way of Example 1. The molecular weight, residual monomer content and properties of the obtained expandable styrene resin particles were measured, and the results are shown in Table 1.

### COMPARATIVE EXAMPLE 3

In a 14-liter autoclave equipped with an agitator, 6,000 g of pure water, 9 g of tricalcium phosphate and 0.12 g of sodium dodecylbenzenesulfonate were charged under an agitation of 230 rpm. Subsequently, 6,000 g of styrene, 24.0 g (Wet 75%) of benzoyl peroxide, 2.4 g of t-butyl peroxyisopropylcarbonate, 3 g of ethylenebisamide and 30 g of dioctylphtalate as a plasticizer were charged under agitation. After completion of charging, the vessel was heated to 90° C. and a pipe for blowing was opened to promote the polymerization. Three g of tricalcium phosphate was added 2 hours and 3 hours after completion of temperature rising, respectively. Then, upon keeping the content of the vessel at 90° C. for 2 hours, 6 g of tricalcium phosphate and 0.12 g of sodium dodecylbenzenesulfonate were added when a rate of polymerization was 95%. At this time, the concentration of oxygen was 13.6 vol %. Thereafter, the temperature was raised to 100° C. over 1 hour.

The procedures thereafter including impregnation with a foaming agent were repeated in the same way of Example 1. The molecular weight, residual monomer content and properties of the obtained expandable styrene resin particles were measured, and the results are shown in Table 1.

TABLE 1

| | | Ex. 1 | Ex. 2 | Ex. 3 |
|---|---|---|---|---|
| Timing of Substitution of Inside of Reaction Vessel with | | Before Start | Before Start | Late Stage of |
| Nitrogen | | of | of | Polymerization |
| | | Polymerization | Polymerization | |
| Reaction rate in | Initial Stage of Polymerization (vol %) | 0.7 | 5.9 | 20.8 |
| Reaction Vessel | Late Stage of Polymerization (vol %) | 0.5 | 3.9 | 6.5 |
| Amount of Additional Styrene Monomers (wt %) | | 10 | 10 | 10 |
| Weight Average | Whole Particle (A) | 298,000 | 292,000 | 286,000 |
| Molecular Weight | ⅕ Portion from Center (central | 223,000 | 225,000 | 215,000 |
| (Mw) | portion) | | | |
| | ⅗ Portion from Center | 225,000 | 227,000 | 217,000 |
| | 6/6 of ⅕ Portion from Surface | 371,000 | 351,000 | 339,000 |
| | (surface portion) | | | |
| | ⅚ of ⅕ Portion from Surface | 374,000 | | |
| | 4/6 of ⅕ Portion from Surface | 382,000 | | |
| | 3/6 of ⅕ Portion from Surface | 385,000 | | |
| | 2/6 of ⅕ Portion from Surface | 392,000 | 352,000 | 340,000 |
| | ⅙ of ⅕ Portion from Surface (B) | 400,000 | 355,000 | 341,000 |

| | | | |
|---|---|---|---|
| Inclination of Correlation Expression of Logarithm (R.M.S | 0.47 | | |
| Radius) and Logarithm (MW) | | | |
| Mw Ratio of Surface Portion/Central Portion | 1.24 | 1.20 | 1.19 |
| (B)/(A) × 100% | 134 | 122 | 119 |
| Total Amount of Volatile Organic Compounds (ppm) | <500 | <500 | <500 |
| Expandability (ml/g) | 63 | 63 | 62 |
| Appearance of 60 ml/g (%) | 93 | 91 | 90 |
| Flexural Strength of 60 ml/g (Mpa) | 0.298 | 0.291 | 0.285 |
| Flexural Strength of 55 ml/g (Mpa) | 0.330 | 0.322 | 0.315 |
| Usable Limit of Expansion Ratio (ml/g) | 60 or more | 60 or more | 60 or more |

| | | Comp. Ex. 1 | Comp. Ex. 2 | Comp. Ex. 3 |
|---|---|---|---|---|
| Timing of Substitution of Inside of Reaction Vessel with | | No | No | No |
| Nitrogen | | | | |
| Reaction rate in | Initial Stage of Polymerization (vol %) | 20.8 | 20.8 | 20.8 |
| Reaction Vessel | Late Stage of Polymerization (vol %) | 13.2 | 13.5 | 13.6 |
| Amount of Additional Styrene Monomers (wt %) | | 0 | 0 | 0 |
| Weight Average | Whole Particle (A) | 299,000 | 256,000 | 254,000 |
| Molecular Weight | ⅕ Portion from Center (central | 298,000 | 254,000 | 251,000 |
| (Mw) | portion) | | | |
| | ⅗ Portion from Center | 297,000 | 256,000 | 251,000 |
| | 6/6 of ⅕ Portion from Surface | 300,000 | 256,000 | 253,000 |
| | (surface portion) | | | |
| | ⅚ of ⅕ Portion from Surface | | | |
| | 4/6 of ⅕ Portion from Surface | | | |
| | 3/6 of ⅕ Portion from Surface | | | |
| | 2/6 of ⅕ Portion from Surface | 298,000 | 257,000 | 255,000 |
| | ⅙ of ⅕ Portion from Surface (B) | 295,000 | 255,000 | 253,000 |

| | | | |
|---|---|---|---|
| Inclination of Correlation Expression of Logarithm (R.M.S | 0.56 | | |
| Radius) and Logarithm (MW) | | | |
| Mw Ratio of Surface Portion/Central Portion | 1.00 | 1.00 | 1.00 |
| (B)/(A) × 100% | 99 | 100 | 100 |
| Total Amount of Volatile Organic Compounds (ppm) | <500 | <500 | <500 |
| Expandability (ml/g) | 59 | 65 | 70 |
| Appearance of 60 ml/g (%) | 85 | 80 | 72 |
| Flexural Strength of 60 ml/g (Mpa) | 0.269 | 0.255 | 0.230 |
| Flexural Strength of 55 ml/g (Mpa) | 0.303 | 0.283 | 0.270 |
| Usable Limit of Expansion Ratio (ml/g) | Less than 60 | Less than 55 | Less than 55 |

In Comparative Examples 1 to 3, the pentane was used as a foaming agent and styrene monomers were not added while lowering the concentration of oxygen. As a result, the amount of VOC contained in the particles obtained was low but the particles had inferior appearance (much shrinkage) and weak flexural strength. Further, the usable limit of expansion ratio thereof was less than 60 ml/g.

Since the expandable styrene resin particles of this invention have low VOC properties and high usable limit of expansion ratio, they can be used for various applications in which care should be taken to the environmental protection and the health of human bodies, and a certain strength is required. Specifically, the molded article of the present invention can be preferably used in food containers, packing materials, cushioning materials and the like.

This application is a continuation-in-part application of U.S. Ser. No. 10/901,970, and the contents of U.S. Ser. No. 10/901,970 are hereby incorporated by reference.

1. A process of producing expandable styrene resin particles, comprising;
suspension-polymerizing styrene monomers,
adding styrene monomers to be adsorbed to styrene resin particles in the course of polymerization, while keeping the concentration of oxygen low by forced discharging of oxygen in a reaction vessel in a late stage of the polymerization, and
impregnating styrene resin particles with pentane as a foaming agent.

2. A process of producing expandable styrene resin particles, comprising;
suspension-polymerizing styrene monomers,
adding styrene monomers to be adsorbed to styrene resin particles in the course of polymerization, while keeping the concentration of oxygen in a reaction vessel at 7 vol % or lower in a late stage of the polymerization, and
impregnating styrene resin particles with pentane as a foaming agent.

3. A process of producing expandable styrene resin particles, comprising;
suspension-polymerizing styrene monomers, while keeping the concentration of oxygen low by forced discharging of oxygen in a reaction vessel from start of the polymerization to a late stage of the polymerization,
adding styrene monomers to be adsorbed to styrene resin particles in the course of polymerization while keeping the concentration of oxygen low, and
impregnating styrene resin particles with pentane as a foaming agent.

4. A process of producing expandable styrene resin particles, comprising;
suspension-polymerizing styrene monomers, while keeping the concentration of oxygen in a reaction vessel at 7 vol % or lower from start of the polymerization to a late stage of the polymerization,
adding styrene monomers to be adsorbed to styrene resin particles in the course of polymerization, while keeping the concentration of oxygen at 7 vol % or lower, and
impregnating styrene resin particles with pentane as a foaming agent.

5. A process of producing expandable styrene resin particles, comprising;
suspension-polymerizing styrene monomers, while keeping the concentration of oxygen in a reaction vessel at 1 vol % or lower from start of the polymerization to a late stage of the polymerization,
adding styrene monomers to be adsorbed to styrene resin particles in the course of polymerization, while keeping the concentration of oxygen at 1 vol % or lower, and
impregnating styrene resin particles with pentane as a foaming agent.

6. The process of producing expandable styrene resin particles according to claim 1, wherein the late stage of the polymerization is a stage in which the polymerization rate is 60% or higher.

7. The process of producing expandable styrene resin particles according to claim 3, wherein the late stage of the polymerization is a stage in which the polymerization rate is 60% or higher.

8. The process of producing expandable styrene resin particles according to claim 1, wherein the amount of the additional styrene monomers is 5 wt % to 30 wt % of the expandable styrene resin particles.

9. The process of producing expandable styrene resin particles according to claim 3, wherein the amount of the additional styrene monomers is 5 wt % to 30 wt % of the expandable styrene resin particles.

10. Expandable styrene resin particles obtained by the process of claim 1.

11. Expandable styrene resin particles obtained by the process of claim 3.

12. An expandable styrene resin particle comprising pentane impregnated therein, wherein the weight average molecular weight of a surface portion from the surface of the particle to a depth of ⅕ of its radius toward the center is higher than that of a central portion from the center to a distance of ⅕ of the radius toward the surface, and a chart of gel permeation chromatography of the surface portion has two crests or a shoulder.

13. The particle according to claim 9, wherein the weight average molecular weight of the central portion is 200,000 to 300,000,
the weight average molecular weight of the surface portion is 300,000 to 450,000, and
the weight average molecular weight of the surface portion is at least 1.2 times as large as that of the central portion.

14. An expandable styrene resin particle comprising pentane impregnated therein, wherein the inclination of a correlation expression of a logarithm (R.M.S radius) and a logarithm (MW), measured by a GPC/MALLS method, of a surface portion from the surface of the particle to a depth of ⅕ of the radius toward the center is not larger than 0.53.

15. An expandable styrene resin particle comprising pentane impregnated therein, wherein when a surface portion from the surface of the particle to a depth of ⅕ of the radius toward the center is further divided into 6 equal portions from the surface toward the center of the particle, the weight average molecular weights of parts constituting from the surface to the ⅙ to 6/6 portions do not decrease toward the surface of the particle.

16. The particle according to claim 12, wherein a ratio (B)/(A)×100(%) is at least 130
wherein (B) is the weight average molecular weight of the outermost portion out of the 6 equal portions, and (A) is the weight average molecular weight of the whole particle.

17. An expandable styrene resin particle comprising pentane impregnated therein, wherein a chart of gel permeation chromatography of a surface portion from the surface of the particle to a depth of ⅕ of the radius toward the center has two crests or a shoulder, and
a ratio (B)/(A)×100(%) is at least 130
wherein (B) is the weight average molecular weight of an outermost portion out of 6 equal portions obtained by dividing the surface portion into the 6 equal portions from the surface toward the center of the particle, and (A) is the weight average molecular weight of the whole particle.

18. An expandable styrene resin particle comprising pentane impregnated therein, wherein the usable limit of expansion ratio of the particles is 60 ml/g or more.

19. An expandable styrene bead obtained by expanding the particle of claim 10.

20. An expandable styrene bead obtained by expanding the particle of claim 11.

21. An expandable styrene bead obtained by expanding the particle of claim 12.

22. An expandable styrene bead obtained by expanding the particle of claim 14.

23. An expandable styrene bead obtained by expanding the particle of claim 15.

24. An expandable styrene bead obtained by expanding the particle of claim 18.

25. A foamed article obtained by molding the beads of claim 19.

26. A foamed article obtained by molding the beads of claim 20.

27. A foamed article obtained by molding the beads of claim 21.

28. A foamed article obtained by molding the beads of claim 22.

29. A foamed article obtained by molding the beads of claim 23.

30. A foamed article obtained by molding the beads of claim 24.

31. A foamed article according to claim 25, whose the expansion ratio is 60 ml/g or more.

32. A foamed article according to claim 26, whose the expansion ratio is 60 ml/g or more.

33. A foamed article according to claim 27, whose the expansion ratio is 60 ml/g or mote.

34. A foamed article according to claim 28, whose the expansion ratio is 60 ml/g or more.

35. A foamed article according to claim 29, whose the expansion ratio is 60 ml/g or more.

36. A foamed article according to claim 30, whose the expansion ratio is 60 ml/g or more.
